(19) United States
(12) Patent Application Publication
(10) Pub. No.: US 2012/0109368 A1
(43) Pub. Date: May 3, 2012

(54) REAL-TIME TARGETED DYNAMIC CONTENT DELIVERY TO A CONSUMER VIA SERVER-DRIVEN MESSAGING

(75) Inventor: James M. Canter, Austin, TX (US)

(73) Assignee: CRANE MERCHANDISING SYSTEMS, INC., Bridgeton, MO (US)

(21) Appl. No.: 13/284,632

(22) Filed: Oct. 28, 2011

Related U.S. Application Data
(60) Provisional application No. 61/408,370, filed on Oct. 29, 2010.

(51) Int. Cl. G06F 17/00; G06F 15/16; G06Q 30/02

(52) U.S. Cl. 700/233; 705/347; 705/14.53; 709/219

(57) ABSTRACT

Content for display to a consumer at a vending machine is dynamically generated at a remote content server based on one or more variables maintained at the content server, and delivered in real time to the vending machine for display to the customer during a vend process. In the case of a customer loyalty program, the content may include metadata comprising an authorization code for a free vend and an associated message if the customer has accumulated sufficient reward points, or a message indicating a number of accumulated rewards points.

### CROSS-REFERENCE TO RELATED APPLICATION(S) AND CLAIM OF PRIORITY

This application claims the benefit of the filing date of commonly assigned U.S. Provisional Patent Application Ser. No. 61/408,370 filed Oct. 29, 2010 and titled “REAL-TIME TARGETED DYNAMIC CONTENT DELIVERY TO A CONSUMER VIA SERVER-DRIVEN MESSAGING”, which is hereby incorporated by reference.

### TECHNICAL FIELD

The present application relates generally to consumer interaction with a vending machine and, more specifically, to targeted dynamic delivery of content to a consumer during a vend process.

### BACKGROUND

Merchandising systems or “vending machines” have long been used to sell products. For example, vending machines are often used to sell beverages and snacks in schools, workplaces, and countless other locations. Consumer messaging at vending machines typically focuses on graphical content at the vending machine, such as through art work on the vending machine cabinet or door or presenting products with their packaging visible. Even when dynamic messaging is delivered at the vending machine, such as by text-based or mixed graphical and text-based messages displayed on a liquid crystal display (LCD) within the vending machine, the content is normally controlled from within the vending machine.

There is, therefore, a need in the art for improved methods of delivering content to a customer making a purchase at a vending machine.

### SUMMARY

According to one embodiment of this disclosure, a method of displaying dynamic content at a vending machine is provided. The method includes obtaining a customer identifier from a consumer at the vending machine as part of a vend process. The method also includes providing the customer identifier to a remote dynamic content server and prompting the remote dynamic content server for dynamic content to display at the vending machine during the vend process. The method further includes receiving dynamic content from the remote dynamic content server based on a variable associated with the customer identifier and maintained at the remote dynamic content server. The method still further includes displaying at least a portion of the received dynamic content to the consumer on a display at the vending machine during the vend process.

According to another embodiment of this disclosure, a device configured for use within a vending machine and capable of receiving dynamic content from a remote dynamic content server is provided. The device includes an interface configured to couple the device to a display within the vending machine that is visible to a consumer. The device also includes a content controller configured to prompt the remote dynamic content server during a vend process for a message to display on the display as part of the vend process, and, upon receipt of content from the remote dynamic content server, to display at least a portion of the received content on the display.

According to yet another embodiment of this disclosure, a vending machine messaging system is provided. The system includes at least one vending machine configured to communicate with a remote dynamic content server. The at least one vending machine includes a display visible to a consumer. The at least one vending machine also includes a content controller configured to prompt a remote dynamic content server during a vend process for a message to display on the display as part of the vend process, and, upon receipt of content from the remote dynamic content server, to display at least a portion of the received content on the display.

Other technical features may be readily apparent to one skilled in the art from the following figures, descriptions and claims.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a simplified perspective view illustrating a vending machine including real-time, targeted dynamic content delivery to a consumer via server-driven messaging according to one embodiment of the present disclosure;

FIG. 2 is a block diagram of a system configured for real-time, targeted dynamic content delivery to a consumer via server-driven messaging, according to one embodiment of the present disclosure;

FIGS. 3A and 3B are state/messaging diagrams illustrating interactions between a consumer, a vending machine and dynamic content server(s) in providing real-time, targeted dynamic content delivery to the consumer via server-driven messaging, according to one embodiment of the present disclosure;

FIGS. 4A and 4B are a flow diagram illustrating provision of real-time, targeted dynamic content delivery to a consumer via server-driven messaging according to one embodiment of the present disclosure; and

FIG. 5 is a block diagram of a mesh network configured for real-time, targeted dynamic content delivery to a consumer via server-driven messaging, according to one embodiment of the present disclosure.

### DETAILED DESCRIPTION

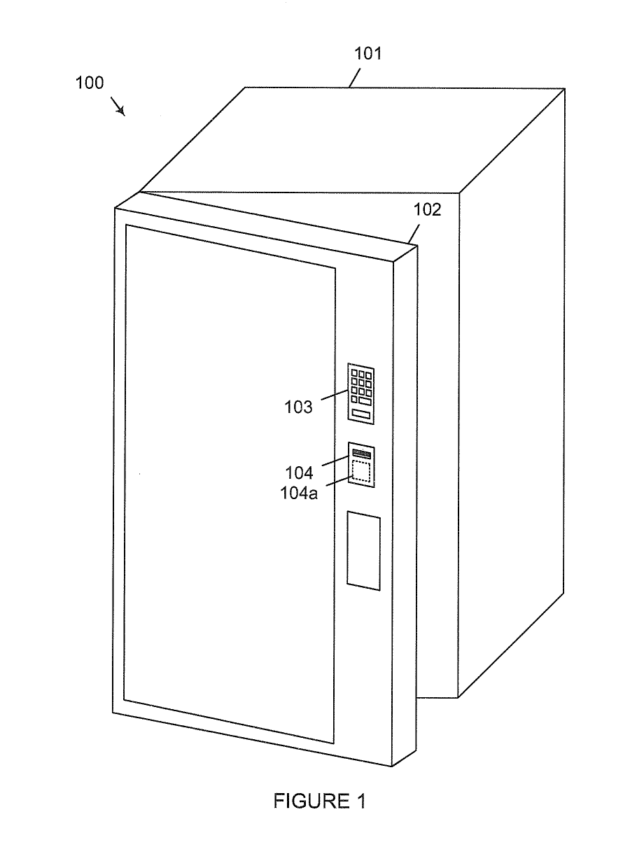

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine.

In accordance with this disclosure, content for display to a consumer at a vending machine is dynamically generated or selected at a remote content server based on one or more variables maintained at the content server, and delivered in real time via an always-on, high speed wireless connection or similar data communication channel to the vending machine for display to the consumer during a vend process. (As used herein, “vend process” includes customer interactions with a vending machine that do not result in purchase and/or delivery of a product, such as failed vend attempts; customer use of a vending machine to access information regarding loyalty reward points, to rate products, or to answer survey questions; or any other vending machine interaction.)

Knowledge of the consumer can be used to drive interaction with the consumer based on the dynamic content. In the case of a customer loyalty program, the content may include metadata comprising an authorization code for a free vend and an associated message if the consumer has accumulated sufficient reward points, or a message indicating a number of accumulated rewards points. In the case of a promotional program, the content may include metadata associated with a new product targeted to the consumer. Similarly, in the case of a survey program, the content may include metadata associated with questions for the consumer to answer, such as the consumer's opinion of a new or existing product.

FIG. 1 is a simplified perspective view illustrating a vending machine 100 that includes real-time, targeted dynamic content delivery to a consumer via server-driven messaging according to one embodiment of the present disclosure. Vending machine 100 includes a cabinet 101 and a service door 102 that, together, define an enclosure. In the exemplary embodiment illustrated, the service door 102 is pivotally mounted to the front of the cabinet 101 and extends all the way across the front face of the vending machine 100. In alternate designs, the service door may extend only part way across the front of the vending machine, or may be formed in two portions (of equal or unequal sizes) that swing open in opposite directions.

In the exemplary embodiment illustrated in FIG. 1, the service door 102 includes a customer user interface 103, illustrated as a keypad and light emitting diode (LED) display or liquid crystal display (LCD). However, the customer user interface 103 may also employ a touchpad input device in addition to or in lieu of the keypad and display. Similarly, a payment system 104 is disposed within the service door 102 and includes one or more of a bill validator, a coin acceptor, a magnetic strip card payment processing device for credit and debit cards, and any other payment reader suitable for receiving payment information from a smart phone, personal electronic device, and the like. (Herein, “personal electronic device” refers to any device generally associated with an individual and capable of communicating data or information, such a mobile phone, iPad®, Bluetooth® device, RFID (radio frequency identification) fob, NFC (near field communication) device, and the like.) The payment system 104 receives currency, coins, electronic payment cards, or other forms of payment from the customer and returns change as necessary. Some payment mechanisms, such as certain commercially available bill acceptors and/or card swipe mechanisms, may include a display 104a separate from the display that forms part of the customer user interface 103.

Those skilled in the art will recognize that the full construction and operation of a vending machine is not depicted or described herein. Instead, only so much of a vending machine as is unique to the present disclosure or necessary for an understanding of the present disclosure is depicted and described. For example, some vending machines may have a large liquid crystal display instead of a glass front as depicted in FIG. 1, which may also form part of the display system used for content delivery in the present disclosure. In addition, the subject matter of the present disclosure may be exploited without independently constructing a complete vending machine. Instead, the subject matter of the present disclosure may be embodied in devices intended for use within a vending machine, such as a device used to retrofit an existing vending machine for communication with a remote telemetry server and the like.

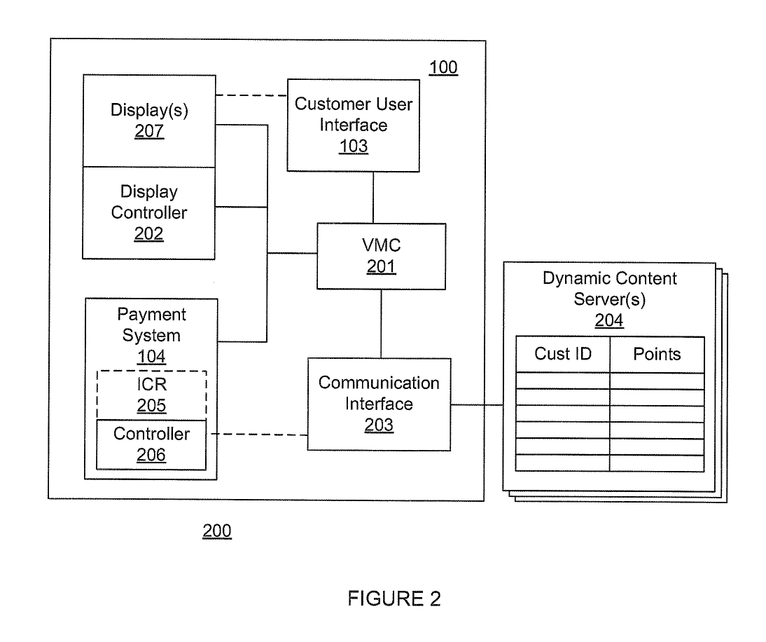

FIG. 2 is a block diagram of a system 200 configured for real-time, targeted dynamic content delivery to a consumer via server-driven messaging, according to one embodiment of the present disclosure. The system 200 includes the vending machine 100 of FIG. 1 and one or more external, remote dynamic content servers 204. The vending machine 100 includes electrical and electronic components associated with the customer user interface 103 and the payment system 104. In addition, the vending machine 100 includes a vending machine controller (VMC) 201 coupled to the customer user interface 103 and the payment system 104. The vending machine 100 also includes one or more displays 207, which may include portions of the customer user interface 103 and/or payment system 104, or may include display devices distinct from those systems. A communication interface 203 couples the VMC 201 to the remote dynamic content server(s) 204.

Coupled to and communicating with the VMC 201 is a display controller 202 for the display(s) 207. The display controller 202 renders content for display on the display(s) 207 and, in the case of a touch screen, detects customer contact with the touch screen for the display(s) 207. Suitable touch-screen display devices and the associated controllers for use as the customer user interface 103, display controller 202, and display(s) 207 are known in the art.

In one embodiment, the payment system 104 includes an interactive cashless reader (ICR) 205 and associated controller 206, which may be implemented in the manner of the cashless reader and audit device described in U.S. Patent Application Publications Nos. 2004/0133653 and 2007/0083287, the content of which is incorporated herein by reference. The ICR 205 and controller 206 may be associated with an additional display, separate from the display(s) 207. Additionally or alternatively, the ICR 205 and controller 206 can access and control content delivered to and displayed upon portions of the display(s) including any displays within the customer selection interface 103 and/or the remainder of payment system 104 (e.g., display 104a). The ICR 205 and controller 206 are configured to communicate with the dynamic content server(s) 204, either through the communication interface 203, through an independent wide-area network (WAN) wireless connectivity channel enabled by components within the ICR 205 and controller 206, through a wired Ethernet connection, or more than one of these communication channels. In embodiments that utilize a WAN, the WAN may be “always on” or may establish ad hoc communications connectivity as needed, in the manner described in further detail below. The ICR 205 and controller 206 may also communicate with the VMC 201 and other subsystems within or external to the vending machine 100 via a National Automatic Merchandising Association (NAMA) multi-drop bus (MDB), a Data Exchange (DEX) protocol communications channel, or both.

Other devices configured for installation within a vending machine and adapted for connection to the display controller 202 and/or customer user interface 103, and for communication with external server(s) 204, may implement the functionality described herein. For example, a telemetry unit coupled on a multi-drop bus (MDB) to a “legacy” VMC 201 to provide communication of product and/or currency inventories, sales, and operational information (e.g., status of a refrigeration unit in the vending machine) to a remote network operations center for the vending machine operator may implement the processes described in further detail below.

In another embodiment, the payment system 104 is fully integrated into the vending machine 100, such as found in CRANE MERCHANDISING SYSTEMS' BevMax-Media and Merchant-Media vending machines. That is, the payment system 104 is not an add-on component, but is integrated into the vending machine 100. In this embodiment, the payment system 104 includes the controller 206. The controller 206 can access and control content delivered to and displayed upon portions of the display(s) 207, including any displays within the customer selection interface 103 and/or the remainder of the payment system 104 (e.g., display 104a). The controller 206 is configured to communicate with the dynamic content server(s) 204, either through the communication interface 203, through an independent wide-area network (WAN) “always on” wired or wireless connectivity channel enabled by components within the controller 206, or both. The controller 206 may also communicate with the VMC 201 and other subsystems within or external to the vending machine 100 via a National Automatic Merchandising Association (NAMA) multi-drop bus (MDB), a Data Exchange (DEX) protocol communications channel, or both.

Although FIG. 2 illustrates one example of a system 200 configured for real-time, targeted dynamic content delivery, various changes may be made to FIG. 2. For example, while the content controller 206 is shown as being part of the payment system 104, in other embodiments, the content controller 206 could be part of the VMC 201 or a stand-alone component in the vending machine 100. Likewise, various other components could be combined, subdivided, or omitted and additional components could be added according to particular needs.

Within the present disclosure, messaging to the consumer on the display(s) 207 within the vending machine 100 is dynamic and is driven by the back-end server(s) 204. The messaging is dynamic in that the content is not fixed—not across a group of consumers and not even for a specific consumer—but is instead derived at the dynamic content server(s) 204 in real time. The messaging is also targeted in that the content is specific to a particular consumer. However, mere personalization (e.g., “Welcome back, Jim.”, where “Jim” is inserted for a generic placeholder <name> field based on information retrieved from a customer identifier) is not “dynamic” as that term is used herein; instead, the term “dynamic” refers to generating or selecting content based on one or more variables maintained within the dynamic content server 204, such as a number of prior purchases by the consumer, as described in the examples below.

To illustrate the operation of the system(s) of the present disclosure, a customer loyalty program will be employed. However, it will be understood that dynamically generated messaging can encompass messages other than those associated with customer loyalty, as described later in this disclosure. For example, the dynamically generated messaging can encompass messages related to promotions, customer surveys, or any other type of customer interaction. In such embodiments, the one or more variables maintained within the dynamic content server 204 may be associated with the consumer's vend purchase history (including dates, locations, and items purchased), the consumer's eligibility for certain promotions, the consumer's demographic information (including age, gender, and the like), or any other suitable information.

In accordance with the customer loyalty program in this example, after N purchases by a particular consumer, a benefit is conferred. The benefit may be a free or reduced-price product. The purchases and/or the benefit may be restricted by type (e.g., soft drinks, snack foods, etc.), by brand, or both. For the purposes of illustration, the loyalty program will be assumed to grant one free product after the purchase of nine products by a given consumer. The consumer will be assumed to convey loyalty identification information to the vending machine 100 before each purchase, such as by swiping a loyalty card through the ICR 205, transmitting a code through a smart phone or another personal electronic device, entering a code on a touch screen on the vending machine, or through any other suitable customer identification and/or purchase history tracking mechanism.

In the present disclosure, when the consumer conveys her loyalty identification to the vending machine 100, a unique customer identifier (anonymous or registered) is transmitted by the controller 206 to the dynamic content server(s) 204, which perform a lookup of the consumer's purchase history and return content to be displayed on the display(s) 207. The content is dynamically generated or selected based on one or more variables within the dynamic content server(s) 204, such a number of accumulated rewards points associated with the customer identifier as depicted in FIG. 2. For instance, the content returned for display may read “You are two purchases away from a free soft drink!”

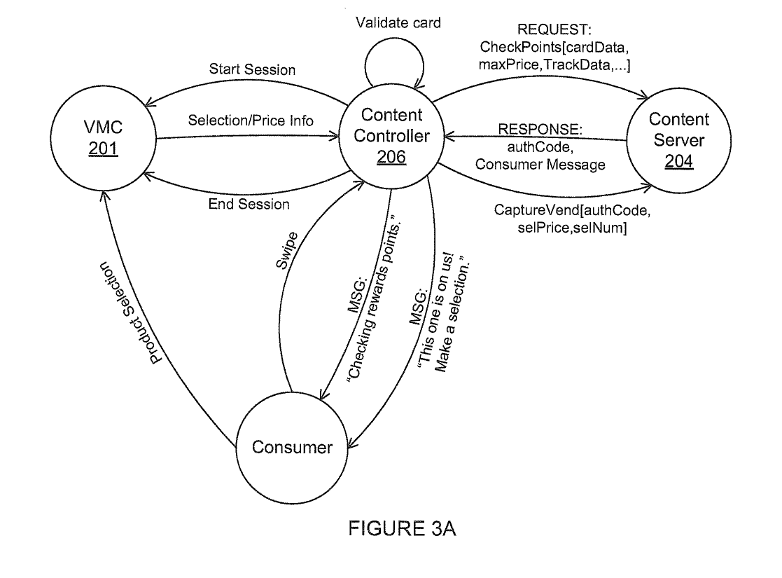

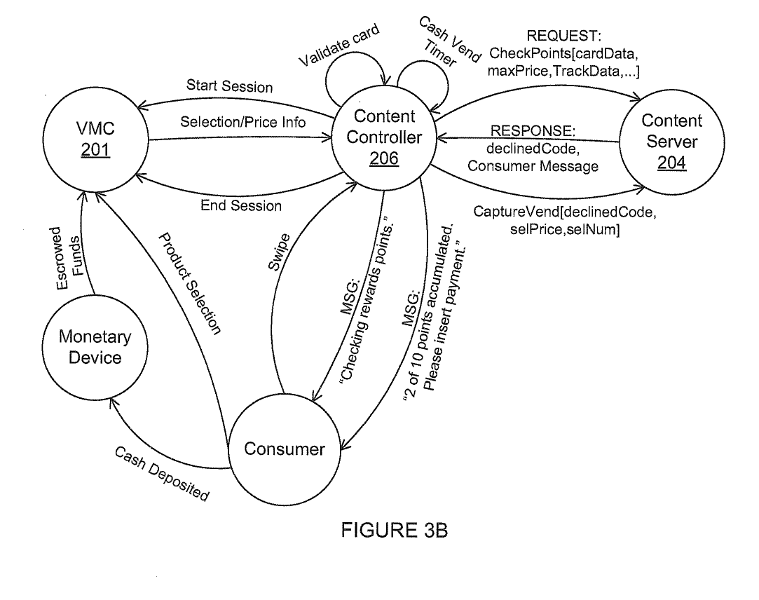

FIGS. 3A and 3B are state/messaging diagrams illustrating interactions between a consumer, a vending machine and dynamic content server(s) in providing real-time, targeted dynamic content delivery to the consumer via server-driven messaging, according to one embodiment of the present disclosure. The sequence of messages depicted in FIG. 3A corresponds to a free vend within the customer loyalty program described above, and begins with the consumer conveying her loyalty identification information, such as by swiping her loyalty card or another method.

The content controller 206 within the vending machine 100 validates the loyalty identification information, then displays a message to the consumer on the display 207 that the vending machine 100 is checking available rewards points. The content controller 206 next sends a request to the dynamic content server 204 to check the consumer's available rewards points, and provides the loyalty information, the maximum price of products within the vending machine 100, tracking data (e.g., a unique identifier for the vending machine 100) allowing the dynamic content server 204 to track the consumer's interaction with the machine, and optionally other information.

The content server 204 returns a response to the content controller 206 containing a free vend authorization code and a consumer message, as well as additional metadata. The response contains a message to the consumer regardless of whether a free vend is authorized or of any other result. The content controller 206 then causes the display 207 to display the message (“This one is on us! Make a selection.”) returned by the dynamic content server 204, and starts a communication session with the vending machine controller 201. The consumer makes a product selection using the customer selection interface 103, and the content controller 206 receives an indication of that product selection from the vending machine controller 201 and ends the communication session with the vending machine controller.

Finally, the content controller 206 delivers information allowing the vend information to be captured, including the free vend authorization code employed (allowing the corresponding reward points to be debited from the consumer's loyalty account), the sale price and an identification of the product selected by the consumer. The product identification and sale price may be null if no vend occurs (e.g., the consumer cancels the vend), but such information is still returned to the dynamic content server 204 to close out the transaction (and maintain the consumer's loyalty rewards points). Additional metadata may also be forwarded by the content controller 206 to the dynamic content server 204.

It should be noted that the consumer may be given the option of “saving” her rewards points by paying for the product selected, in which case the content server 206 would return the same information as if no vend had occurred. Thus, for example, the message returned to the content controller 206 by the dynamic content server 204 may always include an indication of the number of accumulated rewards points, but may vary by asking the consumer whether she wishes to redeem those points only if the number of accumulated points is sufficient, and not include that question if the number of accumulated rewards points is not sufficient.

In an alternative embodiment, the dynamic content displayed to the consumer may have different values depending on the value of one or more variables maintained within the remote dynamic content server 204. For example, the consumer may be offered a discount in exchange for fewer than nine previous purchases, e.g., a $0.50 discount in exchange for five accumulated reward points. Additional steps are included in the vend process consistent with a purchase as described below.

In addition, if personalization information is available (e.g., the loyalty card is registered), the personalization information may be added to the dynamic content (e.g., “Jim, this one is on us! Make a selection.” in lieu of simply “This one is on us! Make a selection.” or “Jim, would you like a $0.50 discount today?” in lieu of simply “Would you like a $0.50 discount today?”). As discussed above, such mere personalization is not considered to constitute “dynamic content” as that term is used herein. “Dynamic content” refers to content generated or selected based on one or more variables maintained within the remote dynamic content server (e.g., the consumer's accumulated reward points). The display of “This one is on us! Make a selection.” when a consumer has accumulated 10 or more rewards points, “Would you like a $0.50 discount today?” when the consumer has accumulated 5 or more (but less than 10) reward points, and “2 of 10 reward points accumulated. Please insert payment.” when the consumer has accumulated less than 5 reward points are examples of “dynamic content” as that term is used herein.

The sequence of messages depicted in FIG. 3B corresponds to a “cash” vend (including credit or debit payment) within the customer loyalty program described above, and once again begins with the consumer conveying her loyalty identification information, such as by swiping her loyalty card or by another method. The loyalty identification information is validated by the content controller 206, which then displays a message on the display 207 that the vending machine 100 is checking available rewards points. The content controller 206 sends a request to the dynamic content server 204 to check the consumer's available rewards points, providing the loyalty information, the maximum product price, tracking data, and optionally other information.

In one exemplary process, the dynamic content server 204 returns a response to the content controller 206 containing a “declined” code and an associated consumer message (e.g., “2 of 10 points accumulated. Please insert payment.”) to be displayed on the display 207, as well as additional metadata. In this case, the content controller 206 starts both a communication session with the VMC 201 and a cash vend timer defining a “timeout” period after which the vend is assumed to have been canceled. The consumer inserts payment into a monetary device within the payment system 104, which signals an amount escrowed to the VMC 201, and then makes a product selection using customer selection interface 103. The VMC 201 sends the product selection and price information to the content controller 206 once payment and selection have both been made. Upon receiving product selection and price information from the VMC 201 prior to the cash vend timer elapsing, the content controller 206 ends the communications session with the VMC 201 and delivers (selection and price) information allowing the vend information to be captured and/or the transaction to be closed, and the consumer's loyalty rewards points to be incremented appropriately. Again, additional metadata may also be forwarded by the content controller 206 to the dynamic content server 204.

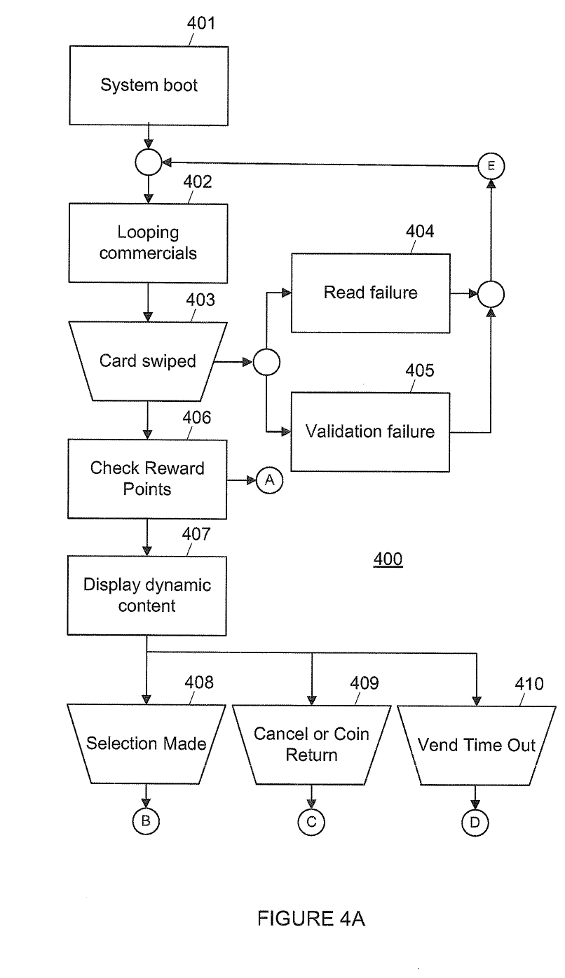

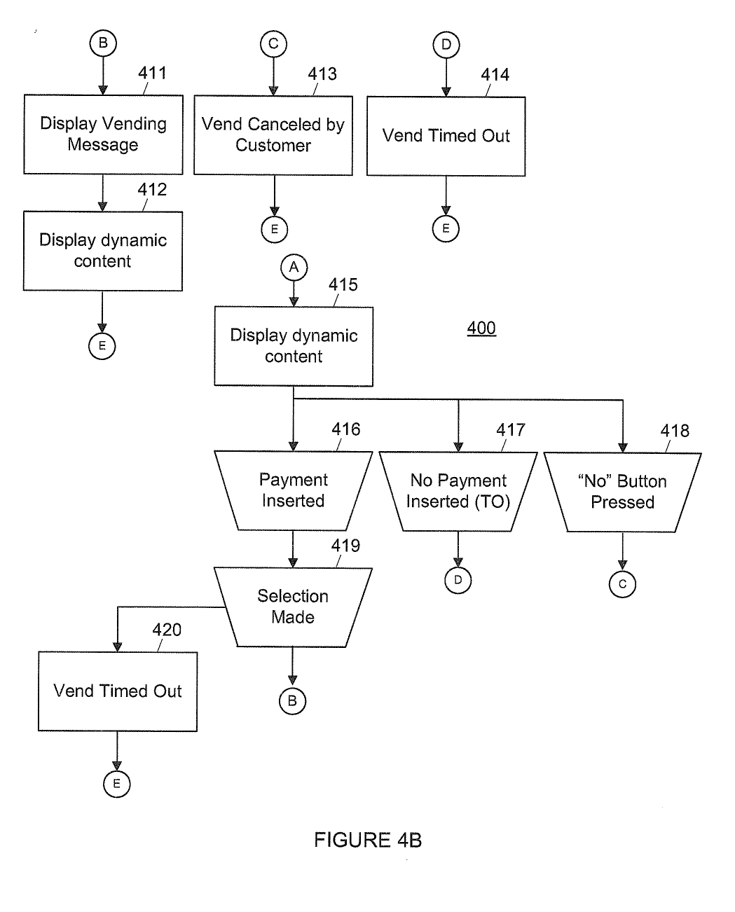

FIGS. 4A and 4B are a flow diagram illustrating provision of real-time, targeted dynamic content delivery to a consumer via server-driven messaging, according to one embodiment of the present disclosure. The process 400 is executed within content controller 206 and begins with system boot (step 401). The process then enters a series of looping commercial messages (step 402) until loyalty information is conveyed by a consumer (step 403). In this embodiment, it is assumed that the consumer swipes a loyalty card, although it will be understood that the user could convey the loyalty information in any suitable way, such as through a smart phone or other personal electronic device. Either a read failure (step 404) resulting from an inability to accurately read the magnetic track on the loyalty card or a validation failure (step 405) resulting from the consumer swiping a card other than the loyalty card (e.g., a credit card) causes a message (e.g., “Please swipe card again.”) to be displayed and/or the process to return to the looping commercial messages upon expiration of a timeout period.

If the swiped loyalty card is successfully read and validated, the process then requests dynamic content from the dynamic content server 204 (step 406) while displaying an appropriate message (e.g., “Checking Rewards Points”) to the consumer. The dynamic content request includes the unique customer/loyalty card identifier, and is preferably sent via an “always on” wired or wireless connection to a wide area network access point to an Internet protocol (IP) network connection and over the Internet to the remote dynamic content server 204. The dynamic content server 204, based on one or more variables maintained therein (the number of accumulated rewards points for the loyalty card swiped) dynamically generates content to be displayed at the vending machine 100 to the consumer. In the case of sufficient rewards points having been accumulated to receive a free vend, the content controller 206 causes the display 207 to display the appropriate content (step 407) received from the dynamic content server 204 (e.g., “This one is on us! Make a selection.”). The process then awaits either a selection by the consumer (step 408), actuation of a “Cancel” button or a coin return by the consumer (step 409), or expiration of a vend timeout period (step 410).

If a selection is received from the consumer (step 408), the process then displays a vending message (step 411), such as “Please wait” and/or an activity indicator. The content controller 206 also sends purchase history tracking information (e.g., the product selected, etc.) to the dynamic content server 204 in the manner described above, and displays a message to the consumer that the loyalty account is being updated based on the selection made. The content controller 206 then receives from the dynamic content server 204 dynamically generated, updated loyalty account information (e.g., “0 of 10 points accumulated for next free vend”) and displays that message to the consumer (step 412). The process then returns to display of the looping commercial messages.

Upon actuation of a “Cancel” button or the coin return by the consumer (step 409), the process instead cancels the vend initiated by the consumer (step 413), and returns to display of the looping commercial messages. Similarly, if no selection is received from the consumer prior to expiration of a vend timeout period (step 410), the process cancels the vend process (step 414) and returns to display of the looping commercial messages.

Returning back to the request for dynamic content from the dynamic content server 204 (step 406), if the loyalty account has not accumulated sufficient rewards points to receive a free vend, the content controller 206 instead receives different dynamic content from the dynamic content server 204 (e.g., “2 more points needed for next free product”) and displays that message to the consumer, prompting the consumer to insert payment (e.g., by displaying a message or by actuating an indicator on the payment mechanism). The process then awaits receipt of payment from the consumer (step 416), expiration of a timeout period without payment being inserted (step 417), or actuation of a vend cancel mechanism (e.g., a “No” or “Cancel” button or the coin return) by the consumer (step 418). If payment is inserted, the consumer is prompted to make a selection and the process awaits receipt of the consumer's selection (step 419). If a product selection is received before expiration of a timeout period (step 420), the selected product is delivered while a vend message is displayed (step 411) and dynamic content is again displayed (step 412).

Although redemption of rewards points under a loyalty program has been used to illustrate one application of dynamic messaging to consumers at vending machines in accordance with the present disclosure, numerous other applications are contemplated. For example, purchase of a snack food from one vending machine may trigger an offer to the consumer, through dynamically generated, targeted messaging delivered in real-time at the vending machine, of a discount on a soft drink purchase from a co-located soft drink vending machine. As another example, promotional messages may be dynamically triggered based on a consumer's previous purchase history. As a specific example, if a consumer regularly purchases one brand of chips, a dynamically generated message might suggest a different brand of chips to the consumer. As yet another example, a dynamically generated message might request the consumer to answer one or more questions about a product before or after a purchase. Those skilled in the art will recognize the range of applications that are enabled by the present disclosure.

As described in the embodiments above, the dynamic content server 204 selects or generates messaging content that is transmitted to the vending machine 100 to be displayed on display(s) 207. In another embodiment, rather than generating or selecting entire messages that are displayed substantially as transmitted, the dynamic content server 204 dynamically selects or generates a code or token associated with messages or content that is pre-loaded in the vending machine 100.

For example, rather than the dynamic content server 204 transmitting the full message “You are two purchases away from a free soft drink!” to the content controller 206, the dynamic content server 204 transmits a code (e.g., ‘P2’) to the content controller 206. The content controller 206 then identifies a message stored in a memory in the vending machine 100 that is associated with code ‘P2’ and displays that message (“You are two purchases away from a free soft drink!”) on the display 207. The messages and content pre-loaded in the vending machine 100 may include textual messages or graphical messages and content, such as a product commercial targeted to the consumer that is making a transaction at the vending machine 100. By transmitting only a code or token associated with a message or content, rather than the entire message or content, the dynamic content server 204 can dynamically select graphically robust content that may be difficult to transmit in real time within the bandwidth constraints of the wireless connection to the dynamic content server 204.

In one embodiment of this disclosure, the system 200 may be implemented as a mesh network, such as described in U.S. Patent Application Publication No. 2009/0303982, the content of which is incorporated herein by reference. In a mesh network, a plurality of vending machines are configured to communicate with each other and with one or more gateways. Mesh networks are often associated with vending machines located within one building or a similar geographical area. Thus, a consumer who works in the building may be likely to visit any or all of the vending machines in the mesh network, but less likely to visit vending machines that are outside of the mesh network.

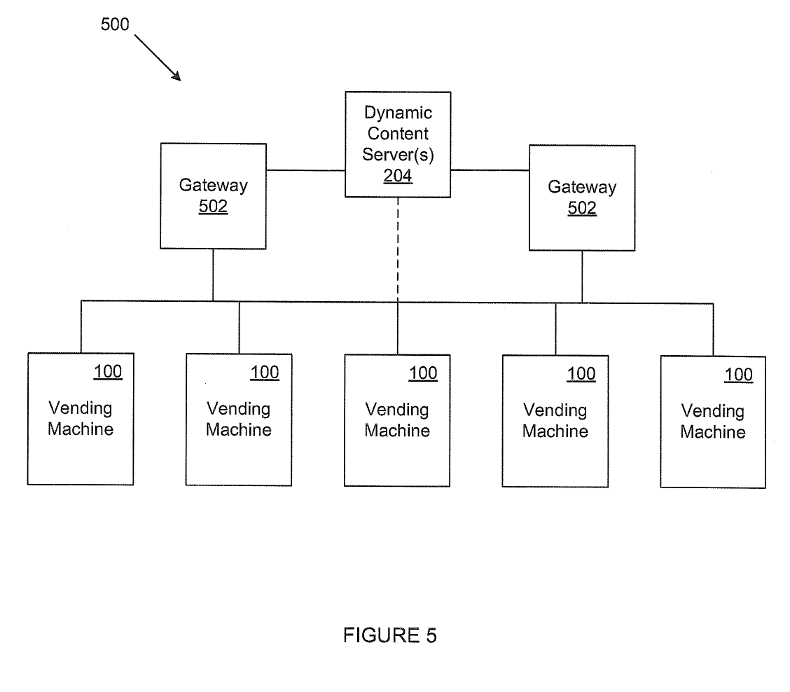

FIG. 5 illustrates a mesh network configured for real-time, targeted dynamic content delivery to a consumer via server-driven messaging, according to one embodiment of the present disclosure. As shown in FIG. 5, the mesh network 500 includes a plurality of vending machines 100 coupled to one or more gateways, represented by gateways 502. The mesh network 500 also includes the dynamic content server 204, which is configured to communicate directly with one or more of the vending machines 100, or communicate indirectly with the vending machines 100 through either or both gateways 502.

Because the vending machines 100 communicate with each other and with the dynamic content server 204, a consumer making a purchase at one vending machine 100 may result in a dynamic message communicated to another vending machine 100. For example, in a customer loyalty program, if the consumer purchases a snack food from one vending machine 100, the dynamic content server 204 may prompt a nearby vending machine 100 to offer a discount to the consumer on the purchase of a soft drink.

In the mesh network 500, the dynamic content server 204 can push all or a portion of the dynamic content delivery capabilities to one or both gateways 502. In such a case, the gateways 502 can act as a virtual dynamic content server. For example, the gateways 502 can collect information from a consumer over multiple visits to different vending machines 100. If the connection to the dynamic content server 204 is lost, one or both gateways 502 can still provide some or all of the dynamic messaging functionality.

The present disclosure allows true dynamic content, not mere personalization, to be displayed to consumers at a vending machine. The limitations associated with generating content solely within an isolated vending machine, rather than across a consumer's global interactions with multiple vending machines, are thus overcome. Brand loyalty, loyalty to an operator's vending machines, collateral sales, and consumer interest and preference information may thus be developed.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A method of displaying dynamic content at a vending machine, comprising:
obtaining a customer identifier from a consumer at the vending machine as part of a vend process;
providing the customer identifier to a remote dynamic content server and prompting the remote dynamic content server for dynamic content to display at the vending machine during the vend process;
receiving dynamic content from the remote dynamic content server based on a variable associated with the customer identifier and maintained at the remote dynamic content server; and
displaying at least a portion of the received dynamic content to the consumer on a display at the vending machine during the vend process.

2. The method of claim 1, wherein obtaining a customer identifier further comprises at least one of: reading a loyalty program card presented by the consumer at the vending machine, obtaining the customer identifier from a personal electronic device presented by the consumer at the vending machine, and receiving an input by the consumer at a touch screen or keypad associated with the vending machine.

3. The method of claim 1, wherein the variable is associated with the consumer's vend purchase history, and wherein receiving dynamic content from the remote dynamic content server further comprises:
receiving a message inviting the consumer to rate a product for sale in the vending machine.

4. The method of claim 1, wherein the variable is a number of accumulated rewards points under a customer loyalty program, and wherein receiving dynamic content from the remote dynamic content server further comprises:
receiving a message to the consumer indicating one or more of the number of accumulated rewards points and a number of rewards points required to receive a free product selection.

5. The method of claim 1, wherein the variable is associated with demographic information associated with the consumer.

6. The method of claim 1, wherein receiving dynamic content from the remote dynamic content server further comprises:
receiving a promotional message inviting the consumer to try a product different from a product previously purchased by the consumer.

7. The method of claim 1, wherein receiving dynamic content from the remote dynamic content server further comprises:
receiving a code associated with graphical content pre-loaded on the vending machine.

8. A device configured for use within a vending machine and capable of receiving dynamic content from a remote dynamic content server, the device comprising:
an interface configured to couple the device to a display within the vending machine that is visible to a consumer;
a content controller configured to prompt the remote dynamic content server during a vend process for a message to display on the display as part of the vend process, and, upon receipt of content from the remote dynamic content server, to display at least a portion of the received content on the display.

9. The device of claim 8, wherein the content controller, in prompting the remote dynamic content server for a message to display, transmits information to the remote dynamic content server allowing the remote dynamic content server to return content based on a variable maintained within the remote dynamic content server.

10. A vending machine including the device of claim 8, the vending machine further comprising:
a vending machine controller configured to control a vend process, wherein the content received by the content controller from the remote dynamic content server determines a manner in which a portion of the vend process proceeds.

11. The vending machine of claim 10, the vending machine further comprising:
a payment device,
wherein the content received by the content controller from the remote dynamic content server controls whether the consumer is prompted to insert payment for a product selection in the payment device.

12. The device of claim 8, wherein the content received by the content controller from the remote dynamic content server is accompanied by an authorization code enabling the vending machine to offer the consumer a free product selection.

13. The device of claim 8, wherein the content received by the content controller from the remote dynamic content server comprises a message inviting the consumer to rate a product for sale in the vending machine.

14. A vending machine including the device of claim 8, the vending machine further comprising:
a customer user interface configured to accept a product selection from a customer.

15. A vending machine messaging system comprising:
at least one vending machine configured to communicate with a remote dynamic content server, the at least one vending machine comprising:
a display visible to a consumer; and
a content controller configured to prompt the remote dynamic content server during a vend process for a message to display on the display as part of the vend process, and, upon receipt of content from the remote dynamic content server, to display at least a portion of the received content on the display.

16. The vending machine messaging system of claim 15, wherein the content controller, in prompting the remote dynamic content server for a message to display, transmits information to the remote dynamic content server allowing the remote dynamic content server to return content based on a variable maintained within the remote dynamic content server.

17. The vending machine messaging system of claim 15, wherein the content received by the controller from the remote dynamic content server determines a manner in which a portion of the vend process proceeds.

18. A network including the vending machine messaging system of claim 15, wherein the at least one vending machine comprises a first vending machine and a second vending machine and a product selection at the first vending machine prompts the remote dynamic content server to transmit a message to the second vending machine.

19. A network including the vending machine messaging system of claim 15, wherein the network is a mesh network, the mesh network further comprising at least one gateway configured to communicate with the at least one vending machine and the remote dynamic content server.

20. The network of claim 19, wherein when a connection between the remote dynamic content server and the at least one vending machine is interrupted, the gateway is configured to provide content to the at least one vending machine on behalf of the remote dynamic content server.
